(19) United States
(12) Patent Application Publication
(10) Pub. No.: US 2006/0067556 A1
(43) Pub. Date: Mar. 30, 2006

(54) Universal earpiece

(75) Inventors: John Bailey, Crawley (GB); Jurgen Kampmeier, Buckenhof (DE); Gunther Pausch, Effeltrich (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/236,090

(22) Filed: Sep. 27, 2005

(30) Foreign Application Priority Data
Sep. 30, 2004 (DE) 10 2004 048 214.4

(51) Int. Cl. H04R 25/00

(52) U.S. Cl. 381/380; 381/151; 381/328

(57) ABSTRACT

An earpiece is to be created for securing an acoustic device to an ear of a user which fits universally, is easy to use and guarantees secure holding characteristics for the acoustic device on the ear. To this end, an earpiece is proposed having a main body, an auditory canal grommet projecting into the auditory canal of the user when the earpiece is worn and a sprung element, whereby the main body, the auditory canal grommet and the sprung element are dimensioned and aligned with one another in such a way that the earpiece is capable of being positioned at least mainly in the concha of the ear of the user and can be fixed in the concha solely by a rotational movement of the earpiece.

### CROSS REFERENCE TO RELATED APPLICATIONS

This application claims priority to the German application No. 10 2004 048 214.4, filed Sep. 30, 2004 which is incorporated by reference herein in its entirety.

### FIELD OF INVENTION

The invention relates to a universal earpiece for securing an acoustic device to a human ear and also a communication device having such an earpiece.

### BACKGROUND OF INVENTION

There are a great many possible applications for earpieces. An earpiece can for example be part of a set of headphones and incorporate an electro-acoustic converter in its interior for delivering an acoustic signal into an auditory canal of a user. In particular, the earpiece can be designed as a headset for a mobile telephone. Furthermore, the earpiece can also be the housing for a hearing aid device which in addition to an electro-acoustic converter also comprises at least one input converter, for example a microphone, as well as a signal processing unit. In addition, the earpiece can also be designed as part of a communication device capable of being worn on the ear. The earpiece is then used at least mainly simply for mounting the communication device on the ear. The communication device in this case can for example be a headset for a mobile telephone, whereby a wireless form of signal transmission is provided between the headset and the mobile telephone.

### SUMMARY OF INVENTION

Particularly in the case of earpieces for mounting acoustic devices on the ear, the problem frequently presents itself whereby the fixing is only insufficiently effective and, for example, rapid movements of the head result in the acoustic device detaching itself from the ear. One method of avoiding this is to use earpieces individually adapted to the earpiece wearer in question, which project particularly deeply into the auditory canal of the wearer and thus offer a good and effective means of fixing. Individually produced earpieces are however complex to manufacture and thus expensive.

A headset for securing a functional device is known from EP 1 377 113 A2. This is provided for fixing an acoustic device to an ear of a user with an insert body for insertion into the concha of the ear. A flexible, stiff yoke is secured to the insert body of the earpiece for placing in contact with the concha.

A universally fitting earpiece is known from WO 02/052890 A1, which when worn is introduced partially into the auditory canal of a user. A sprung element is attached to the earpiece, which when fitting the earpiece with the fingers is pushed into the concha of the ear in question. Correct fitting of the known earpiece is however usually achieved successfully only with practice and a great deal of manual dexterity.

An object of the present invention is to develop a universally fitting earpiece which offers a good fixture on the ear and can be fitted simply and quickly. It is also an object of the invention to improve the fastening and fixing of an acoustic device on the ear.

This object is achieved by a universal earpiece for fastening an acoustic device to an ear of a user, having a main body, an auditory canal grommet projecting into the auditory canal of the user when the earpiece is worn and a sprung element, whereby the main body, the auditory canal grommet and the sprung element are dimensioned and aligned with one another in such a way that the earpiece is capable of being positioned at least mainly in the concha (D, G) of the ear of the user and can be fixed in the concha solely by a rotational movement of the earpiece. The object is also achieved by an acoustic device having an earpiece of such a type.

As a result of the special design of the earpiece, in spite of its small size good holding characteristics and a good fit are achieved for the ears of the majority of people, although these can differ significantly from one another in respect of their size and form. For fastening purposes it is not necessary to use the fingers to bend a spring into the ear or to execute a complex movement comprising more than two steps in order to fix the earpiece in the ear, as is the case with regard to known earpieces.

### BRIEF DESCRIPTION OF THE DRAWINGS

The invention will be described in detail in the following with reference to an embodiment. In the drawings:

FIG. 1 shows a right human ear,

FIG. 2 shows a top view of an earpiece according to the invention,

FIG. 3 shows the rear view of the earpiece according to FIG. 1,

FIGS. 4+5 show further views of the earpiece according to FIG. 1,

FIGS. 6A+6B show the insertion of an earpiece according to FIGS. 1 to 5 into a right human ear,

FIG. 7 shows a perspective view of the earpiece according to the invention inserted into a right human ear,

FIG. 8 shows a hearing aid device with an earpiece according to the invention,

FIG. 9 shows a top view of an earpiece according to the invention with a mounting facility for an acoustic device,

FIG. 10 shows the rear of the earpiece according to FIG. 9,

FIG. 11 shows an acoustic device with an earpiece according to the invention.

### DETAILED DESCRIPTION OF INVENTION

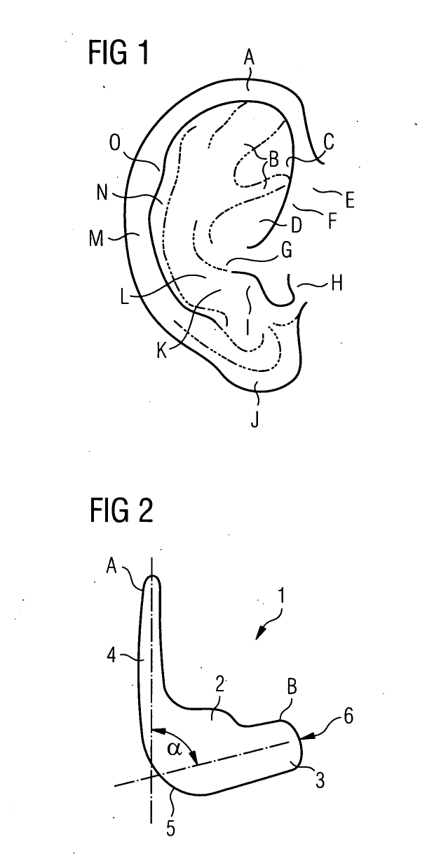

FIG. 1 shows a right human outer ear whose prominent parts are designated as follows:

A Helix

B Crura anthelicis

C Fossa triangularis

D Cymba conchae

E Incisura anterior auris

F Crus helicis

G Concha auriculae

H Tragus

I Antitragus

J Lobulus auriculae

K Fissura antitragohelicina

L Anthelix

M Helix

N Scapha

a. Tuberculum auriculae

FIG. 2 shows the distal side of an earpiece 1 according to the invention, capable of being worn in the right ear, when the earpiece 1 is worn. The earpiece 1 comprises a bulbous main body 2 which changes over into an auditory canal grommet 3. When the earpiece 1 is worm, the auditory canal grommet 3 partially projects into the auditory canal of the right ear of the wearer. The auditory canal grommet 3 is tapered slightly compared with the bulbous main body 2, whereby the underside of the bulbous main body 2 changes over rectilinearly into the auditory canal grommet 3. At its left side the bulbous main body 2 changes over into a sprung element 4 which takes the form of an elongated, slim, essentially pin-shaped extension of the main body 2. The sprung element 4 and the auditory canal grommet 3 are aligned at an angle of between 60° and 100°, preferably about 80°, to one another. The transition between the sprung element 4, the main body 2 and the auditory canal grommet 3 is smooth on the left or lower side of the earpiece 1. Furthermore, the main body 2 takes the shape of an arc in its transition area 5 between the sprung element 4 and the auditory canal grommet 3. It is particularly this smooth arc-shaped profile of the earpiece 1 which enables a rotational movement to be applied to an earpiece 1 inserted into the concha of a relevant ear. By using such a rotational movement, the earpiece 1 can be fixed in the auricle of the wearer. In this situation, the fixing essentially takes place by means of three areas in which the earpiece 1 makes contact with the ear of the user. The first of these is the area B which projects into the auditory canal and makes contact with the upper side of the opening of the auditory canal. In addition, the earpiece 1 is in contact with the length of the anthelix L of the right ear in the area of the arc 5 of the main body 2 and also in the area A of the sprung element 4. The special alignment and dimensioning of the components of the earpiece 1 enables simple, fast and secure fixing of the earpiece 1 in the case of almost all human ears. In particular, the implemented diameter of the auditory canal grommet 3 is relatively small, preferably in the range between 5 and 8 mm. Since the auditory canal entry usually has a larger diameter (10 mm for example), the auditory canal grommet 3 can be rotated in the area of the auditory canal entry and does not necessarily need to point exactly in the direction of the auditory canal. The lengthwise extent of the main body 2 and of the sprung element 4 together comprise about 20 mm to 30 mm, preferably about 25 mm, and the lengthwise extent of the main body 2 and of the auditory canal grommet 3 together comprise about 16 mm to 26 mm, preferably 21 mm.

The earpiece 1 preferably consists at least partly of a soft rubber material, which serves to improve the wearer comfort. The soft rubber material advantageously exhibits a Shore hardness of between 40 Shore and 90 Shore, preferably about 50 Shore. Apart from the improvement in wearer comfort, the soft rubber material also plays a role in the avoidance of acoustic feedback. In addition, the earpiece 1 can thus also be manufactured in just a single operation with an acoustic channel in its interior. Interfaces between multiple parts are avoided by this means.

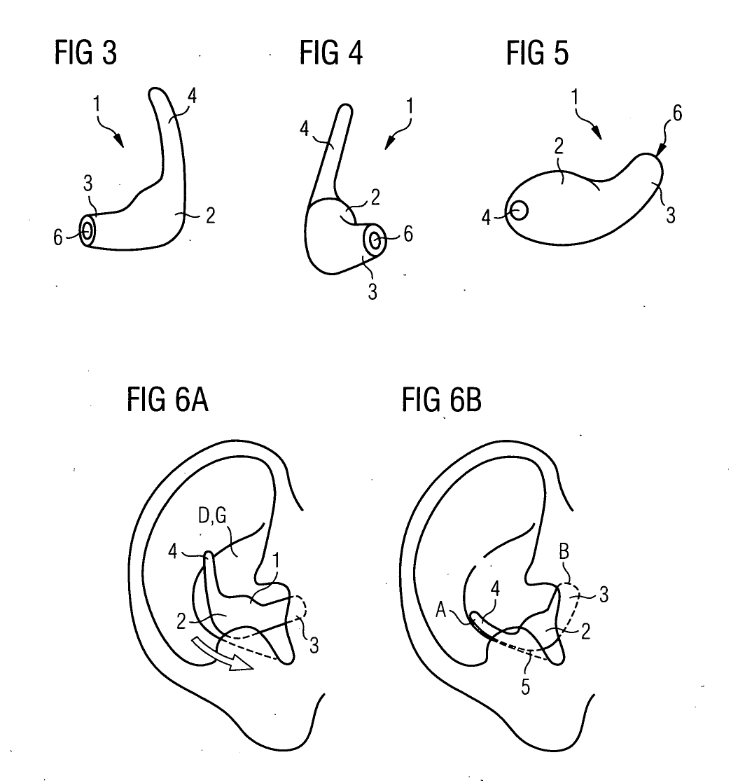

FIGS. 3 to 5 show further views of the earpiece according to FIG. 2. The proximal side of the earpiece 1 according to FIG. 2 is thus represented in FIG. 3. When the earpiece 1 is worn, this side faces towards the head of the wearer; it is thus the proximal side of the earpiece 1. In addition to the aforementioned shaped components, main body 2, auditory canal grommet 3 and sprung element 4 of the earpiece 1, a sound exit opening 6 can be seen in this view. This opening can be seen in the view as per FIG. 3 but not in the view as per FIG. 2 because the auditory canal grommet 3 in total runs in an arc out of the drawing plane with regard to the view as per FIG. 3 and in an arc into the drawing plane with regard to the view as per FIG. 2. This arced course is also particularly clear from the side view according to FIG. 4. In addition, the smooth, arced shape of the side of a worn earpiece making contact in the concha of the ear in question is also clear from FIG. 4. By this means, the earpiece 1 can also be simply inserted and fixed in the ear and can be worn comfortably and conveniently without causing painful pressure points.

Finally, FIG. 5 shows a top view of the earpiece 1 according to FIG. 2, in other words in the direction of the sprung element 4. The smooth, arced shape of the earpiece 1 and also the auditory canal grommet 3 projecting into the auditory canal of a relevant ear can also be seen from this view.

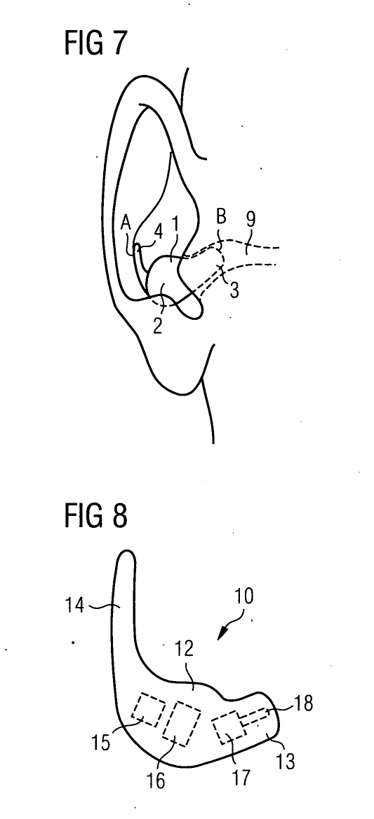

The insertion of an earpiece 1 in accordance with the embodiment represented in FIGS. 2 to 5 is illustrated in FIGS. 6A, 6B and 7. The figures show a right human ear, whereby essentially only those areas of the ear that are relevant in connection with the invention have been drawn. In a first step, the earpiece 1 is introduced into the concha D, G of the right ear, whereby the auditory canal grommet 3 is already inserted a little way into the auditory canal 9. A rotational movement then takes place in the direction shown by the arrow until the earpiece 1 is finally situated in the position shown in FIG. 6B, in which a slight rotation of the earpiece 1 in the direction indicated is no longer possible. In this state, a forward area B of the auditory canal grommet 3 is in contact with the auditory canal entry of the right ear, and the arc-shaped area 5 of the main body 2 as well as the sprung element 4 and in particular the forward area A of the latter is in contact along the anthelix L of the right ear. In addition, in this position the main body 2 is partially concealed by the tragus H and also by the antitragus 1 of the right ear. As a result, the earpiece 1 is held relatively securely in the right ear. Different ear anatomies are taken into consideration particularly by the fact that only a relatively small rotational movement is possible in the direction indicated in the case of one ear while in the case of another ear the earpiece 1 can be rotated relatively far until a distinct resistance is reached. In particular, the length of the sprung element 4 is selected such that this is introduced completely into the concha D, G as a result of the rotational movement and is in contact with the anthelix L. No additional positioning of the sprung element 4 by using the fingers is required when the sprung element 4 is dimensioned and aligned according to the invention.

FIG. 7 illustrates the final position of the earpiece 1 according to FIG. 6B from a different perspective. In this view, the curvature of the auditory canal grommet 3 into the auditory canal and also the position of the area B, in which the auditory canal grommet 3 is in contact with the auditory canal entry, can be recognized in particular.

The invention offers the advantage that the fixing of the earpiece 1 in the ear following introduction into the concha D, G is effected solely by means of a simple and very quickly learned rotational movement. In addition, the invention offers the advantage that secure fixing of the earpiece 1 can be achieved for almost all human ears by means of a relatively simple design for the earpiece 1. In particular, the fixing is secure to such an extent that the earpiece can be used as the carrier for an acoustic device which can be many times the size of the earpiece but still be securely fixed to the ear.

FIG. 8 illustrates an embodiment of an earpiece 10 according to the invention, which is simultaneously designed as a housing for a hearing aid device that can be worn in the ear. In addition to an auditory canal grommet 13, a sprung element 14 and also a bulbous main body 12, the earpiece 10 thus also comprises an input converter, which preferably takes the form of a microphone 15, a signal processing unit 16 for the processing and frequency-dependent amplification of an acoustic input signal picked up by the microphone 15, and also an earphone 17 which delivers an acoustic output signal and places it by way of a sound channel 18 into the auditory canal of a user. The hearing aid device equipped thus which can be worn in the ear can be used universally in respect of its fitting capabilities and can accordingly be manufactured cost-effectively as a result. The special design according to the invention gives it comfortable and secure holding characteristics in the ear.

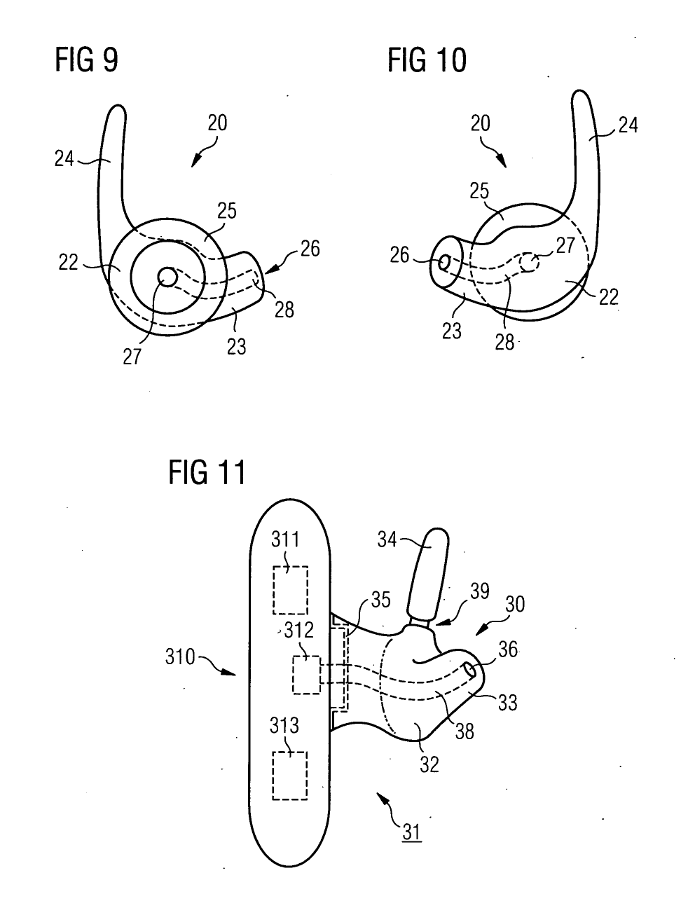

A further embodiment of the invention is shown in FIGS. 9 and 10. In this situation, an earpiece 20 according to the invention which is equipped with a fixing facility for fixing an acoustic device (not shown) is illustrated in two different views. Apart from the fixing facility 15, according to the invention the earpiece 20 has a similar design to that described for the preceding embodiments. The earpiece 20 thus also comprises a bulbous main body 22, an auditory canal grommet 23 and also a sprung element 24. The earpiece 20 can thus, in the same way as in the case of the preceding embodiment, be inserted into the ear of a user and be fixed there solely by means of a simply executed rotational movement. In contrast to the preceding embodiment, in the embodiment according to FIGS. 9 and 10 the earpiece 20 additionally serves as a carrier for an acoustic device. The acoustic device in question is preferably a communication device or a hearing aid device.

The fixing facility 22 for fixing the acoustic device (not shown) to the earpiece 20 is located on the distal side of the earpiece 20 when the earpiece 20 is worn. In the embodiment it has a disk-shaped surface which works together with a similarly disk-shaped fixing facility for the acoustic device in such a way that the acoustic device can be rotated around an axis with respect to the earpiece 20. In the center of the fixing facility 25 is located an opening 27 which is linked to the sound exit opening 26 by way of a sound channel 28. Acoustic signals from the acoustic device are delivered into the auditory canal of a user by way of the openings 26 and 27 and also the sound channel 28.

The connection between the acoustic device and the earpiece 20 by means of the fixing facility 25 is not restricted to one particular mode of fixing. Both releasable connections (clip connection, snap-in fastener, threaded connection, clamp connection etc.) and also non-releasable connections (adhesive, fusion etc.) can be provided. Furthermore, it is also possible for the earpiece 20 and the housing of the acoustic device connected to it to be formed as a single piece.

FIG. 11 illustrates an acoustic device 31 with an earpiece 30 according to the invention. The acoustic device in question is for example a hearing aid device or a communication device, in particular a headset whereby a wireless form of signal transmission with a mobile telephone is possible. To this end, the acoustic device 31 comprises a send and receive unit 311 for wireless signal transmission between the acoustic device 31 and the mobile telephone. In addition, the acoustic device 31 comprises a signal processing and control unit 313 for controlling the signal transmission and processing of received signals. Furthermore, the acoustic device 31 comprises an earphone 312 which converts received and further processed signals into acoustic signals and feeds them by way of a sound channel 38 and a sound exit opening 36 to the auditory canal of a user.

The housing of the acoustic device 31 is subdivided into a housing part 310 and an earpiece 30. In the same way as the preceding embodiments the earpiece 30 comprises a bulbous main body 32, an auditory canal grommet 33 and also a sprung element 34. As a special feature differing from the preceding embodiments the earpiece 30 in the embodiment according to FIG. 11 has fixing facilities 39 for fixing the sprung element 34 to the main body 32 in a releasable manner. As a result, it is possible in a simple manner to provide, for example, sprung elements 34 of differing lengths or rigidity of the spring. In addition, the fixing facilities 39 have a notch between the main body 32 and the sprung element 34, with the result that this area in particular experiences a relatively high degree of bending when an external force is applied to the sprung element 34.

The housing part 310 can be permanently connected to the earpiece 30, also particularly as a single piece. In the embodiment, however, a releasable connection is established between the housing part 310 and the earpiece 30 by means of a fixing facility 35. In this situation, the housing part 310 can when connected to the earpiece 30 be rotated with respect to the earpiece 30. It is thus possible to achieve a particular alignment of the housing part 310 when the earpiece 30 has been inserted and fixed in the ear of a user. This is advantageous particularly if the acoustic device 31 also comprises a microphone (not shown) which accepts voice signals from the user. The microphone can thus be simply aligned in the direction of the mouth of the user.

The releasable connection between the housing part 310 and the earpiece 30 is preferably of a form such that the alignment of the housing part 310 with respect to the earpiece 30 is set once and then retained for a particular user. To this end the fixing facilities 35 comprise for example an adjustment screw (not shown) which can be used after a one-off alignment of the housing part 310 with respect to the earpiece 30 has been made to fix this alignment in such a way that the alignment is also retained when the acoustic device 31 is fitted or removed.

The invention makes it possible to secure the acoustic device quickly and simply to the ear without requiring a great deal of practice or manual dexterity to achieve. In particular, the acoustic device 31 can be gripped with one hand by the housing part 310 and introduced into the concha of the relevant ear, whereby the auditory canal grommet 33 is already inserted a little way into the auditory canal. Fixing is then effected solely by means of a rotational movement which is to be performed in the counterclockwise direction in the case of the acoustic device 31 according to the embodiment which can be worn in the right ear.

The embodiments shown for a right human ear can naturally also be produced in a mirror-image form and provided for wearing on the left ear. In this situation, an earpiece introduced into the concha of the left ear is fixed in the ear by means of a rotational movement in the clockwise direction. Provision for both sides (binaural), using two appropriately equipped devices, is naturally also possible.

1.-16. (canceled)

17. An Universal earpiece for securing an acoustic device to an ear of a user, comprising:
a main body;
an auditory canal grommet configured to project into an auditory canal of the user when the earpiece is worn by the user; and
a spring element, wherein the main body, the auditory canal grommet and the spring element are sized, configured and arranged such that the earpiece can be accommodated essentially within a concha of the user and be fixed within the conch by applying a rotational movement to the earpiece.

18. The earpiece according to claim 17, wherein the rotational movement is a counterclockwise rotational movement if the earpiece is worn in the concha of the right ear of the user.

19. The earpiece according to claim 17, wherein the rotational movement is a clockwise rotational movement if the earpiece is worn in the concha of the left ear of the user.

20. The earpiece according to claim 17, wherein the spring element and the auditory canal grommet are aligned at an angle of between 60° and 100° to one another.

21. The earpiece according to claim 17, wherein the main body is arranged between the spring element and the auditory canal grommet and shaped as an arc in an outer area of the main body being in contact with the concha when the earpiece is worn by the user.

22. The earpiece according claim 17, wherein at least the main body and the auditory canal grommet are integrally formed as one piece.

23. The earpiece according to claim 17, wherein the auditory canal grommet has a curved shape relative to the main body and the spring element such that the auditory canal grommet projects into the auditory canal when the earpiece is worn.

24. The earpiece according to claim 21, wherein at least first, second, and third areas of the earpiece are in contact with the auditory canal of the user when the earpiece is worn by the user, the first area being the arc-shaped outer area of the main body, the second area being at least a part of the spring element, and the third area being at least a part of the auditory canal grommet.

25. The earpiece according to claim 17, wherein the earpiece is a housing for accommodating the acoustic device.

26. The earpiece according to claim 17, wherein at least the main body and the auditory canal grommet are made of a soft rubber material.

27. The earpiece according to claim 26, wherein the rubber material has a Shore hardness of between 40 and 90.

28. The earpiece according to claim 27, wherein the Shore hardness is 50.

29. The earpiece according to claim 17, wherein the spring element is connected to the main body using a detachable connection.

30. The earpiece according to claim 17, wherein the spring element has a notch in a transition area relative to the main body.

31. An acoustic device, comprising:
an earpiece; and
a housing part, wherein
the housing part is located immediately in front of an auricle of a user wearing the acoustic device using the earpiece, and the earpiece comprises:
a main body;
an auditory canal grommet configured to project into an auditory canal of the user when the earpiece is worn by the user; and
a spring element, wherein the main body, the auditory canal grommet and the spring element are sized, configured and arranged such that the earpiece can be accommodated essentially within a concha of the user and be fixed within the conch by applying a rotational movement to the earpiece.

32. The acoustic device according to claim 31, wherein the housing part and the earpiece are integrally formed as one piece.

33. The acoustic device according to claim 31, wherein the housing part is connected to the earpiece using a detachable connection.
